(19) United States
(12) Patent Application Publication
(10) Pub. No.: US 2021/0049558 A1
(43) Pub. Date: Feb. 18, 2021

(54) Calendaring Systems and Methods Using Generating Functions For Prioritized Reminders

(71) Applicant: Henry Bruno Kon, Lexington, MA (US)

(72) Inventor: Henry Bruno Kon, Lexington, MA (US)

(21) Appl. No.: 16/993,835

(22) Filed: Aug. 14, 2020

Related U.S. Application Data
(60) Provisional application No. 62/887,206, filed on Aug. 15, 2019.

(51) Int. Cl. G06Q 10/10

(52) U.S. Cl. CPC G06Q 10/1093

(57) ABSTRACT

Systems, methods and computer program products are introduced for generating prioritized reminders as a time series. Reminder initiation includes selection of an appropriate reminder delivery method. Exemplary embodiments include creating an event having an event time in the electronic calendar and assigning a reminder rate as a parameter to a time series generating processor. The generating function outputs a series of reminder times such that inter-reminder times continuously decrease and that the reminder series, in its initial form, is defined as unending. Additional exemplary embodiments include assignment of an importance to the event as a measure of the relative value or worth of the event to the calendar user. Time remaining to the event, alone or in combination with event importance, are used to determine reminder priority and thus delivery method or delivery mode, based on user configuration preferences for reminder volumes. Additional exemplary embodiments include a method for cancelling or rate-limiting the time series to prevent reminders from coming too frequently or coming beyond their point of being useful as the event time approaches.

### RELATED APPLICATIONS

This application claims the benefit under 35 USC 119(e) of U.S. Provisional Application No. 62/887,206, filed on Aug. 15, 2019, which is incorporated herein by reference in its entirety.

### BACKGROUND OF THE INVENTION

People's schedules are increasingly stored and managed on computer and mobile computing device applications. The calendar system can execute entirely on the user device as an application program (app) or the apps can access a cloud backend server system, on which data is stored. Hybrid calendar systems also exist where the data is stored on the user device and on the cloud backend. It is also common to access the cloud backend via a browser app.

Calendar systems are used to track events, among other things. Events, such as might be created by a user for a meeting, friend's birthday, or a task due date, will typically include information such as a title, time of event information such as a begin time and end time, guest list, conferencing modality, location, and textual description. The begin time and end time will typically be expressed as “Year-Month-Day Hour:Minute,” for example. This information will typically be stored as a record in a data structure maintained by the server system and/or user device.

Events in these calendar systems will also specify the nature of event reminders. Reminders are typically notifications sent to the user via their user device(s) prior to and at the begin time of a calendar event. Often, the user can specify the delivery method of the event reminders by configuration of the calendar system or as part of the setup of corresponding event. On a personal computer user device, the delivery method might often take the form of a popup window and an audible tone. Text messages and emails are other common reminder delivery methods. The timing of the event reminders is also specified by configuration of the calendar system or as part of the setup of corresponding event. Common default settings for an event reminder time might be for a reminder to be generated 15 minutes before the event's begin time.

### SUMMARY OF THE INVENTION

In modern electronic calendaring systems, users schedule event reminders manually by enumeration with individual time and delivery method specified for each reminder, for example to remind: “five days prior to the event via email” and again “on February 2 at 2 p.m. via text message”. Listing reminders individually is tedious, verbose and error prone. It forces the calendar user to think concretely in a non-abstract way and in detail about timings, many of which are often somewhat arbitrary.

In addition, it is possible for users to have many such calendar events, each having multiple reminders, and thus to eventually become overloaded with many reminders and to begin to ignore them. Reminders are typically undifferentiated as to priority and as to preferred reminder device. Where device is specified at all, it is again manually by enumeration.

Using a simple ordinal measure such as a number or percentage, the present approach provides a reminder time series generator with reminder times defined by a mathematical generating function or recurrence relation function. Such a generating function might output a reminder time series, or alternatively might output a series of inter-reminder time spans called dwell periods.

In one embodiment, a reminder rate of 50% as input to the calendar system means the next reminder will occur halfway between the last reminder (or time zero) and the time of the event. For example, reminders for an event 12 months from now would be scheduled by a 50% reminder rate at <6, 3, 1.5, 0.75, . . . > months before the event. The first reminder would be 12×(0.5) months before the event, the second 12×(0.5)² months after the first, and so forth.

This series reminder rate of 50% can be varied up and down by the user via a user interface, causing next reminders to come sooner and more often or later and less often respectively, based on the user's choice.

As a second example consider a reminder rate of 90% which, under the preferred embodiment, implies a next reminder at 12×(1-0.9) months away (or a little more than a month away) for an event that is 12 months away. (The “one minus” orientation in the expression is used so that a higher reminder rate corresponds to more reminders, offering the desired “up/down” orientation.)

The present invention concerns the definition and translation of a compact representation of reminder rate into an intuitive and explicit series of scheduled reminders via a mathematical generating function.

The present approach can also translate a calculated numeric reminder priority into a delivery method. Reminder priority may be based on time remaining to the event as of the reminder time. Reminder priority may also be based on a user entered numeric event importance. In the preferred embodiment, reminder importance is the ratio of event importance to time remaining to the event.

The goal is for a compact representation and system to allow for easy articulation and management of assorted non-terminating reminder series. This is combined with systems and methods for delivery method selection relative to a dynamically changing reminder priority.

Using a compact representation, it can be used for calendaring and event reminder management, providing to the user a service for easily generating and expressing event reminders and automated selection of reminder delivery method.

In a preferred embodiment, a reminder rate such as 50% might be set as a default rate in the user interface and indicates that each successive next reminder will occur halfway further to the event. This percentage repeats for each next reminder period. At any percentage level between 0 and 100, this defines a mathematical generating function with exponential decrease in dwell period length (inter-reminder time) over reminder periods. The reminder rate can differ across series and can be adjusted up or down within a series over time.

The benefit of this unending series approach is that the user need never set a ‘next reminder’ as reminders continue indefinitely by default. A compact user input scalar defines many reminder times, derived from applying the same mathematical function at each reminder period in order to derive a next reminder. The use of a common functional form allows the user to specify and conceptualize reminder series in a familiar common or recurring pattern. Other functional forms (besides those defining an exponential dwell decrease) could be used in addition or as an alternative.

A generating function is a way of encoding an infinite sequence of numbers, expressed in closed form rather than as a series. Under the generating function as defined in the preferred embodiment, the dwell (inter-arrival) time leading to the nth reminder is given as

dₙ=T₀/(1−r)ⁿ
where n is the index of the reminder period (n=1 for first reminder),
dₙ is the length of the dwell period before the n^{th} reminder,
r is the reminder rate, and
T₀ is the time remaining to the event as of reminder series create time.

At a reminder rate of 50%, as of each reminder the upcoming dwell period is half of the time then remaining. A feature of the current invention is that dwell time can be continually decreased so reminders automatically come more often as event time approaches.

The use of “1−r” rather than simply “r” is done so that a larger reminder rate leads to more frequent reminders as expected and intuitive.

This example generating function provides the same reminder times when expressed as a recurrence relation as follows, wherein the time of a next reminder is calculated as a function of the prior reminder time

tₙ=tₙ₋₁+Tₙ₋₁×(1−r)
where tₙ is the time of the n^{th} reminder,
Tₙ₋₁ is the time from the previous (‘n−1’^{th}) reminder to the event, and
t₀ is reminder create time.

In this example recurrence relation, next reminder times are a function of previous reminder times. Equivalent recurrence functions could be applied to recur on dwell periods.

Events may be assigned a user entered numeric event importance, which might variously represent the user's estimation of the personal value of attending an event, of completing a task, or the amount of preparation time required for an event.

In a current embodiment, the delivery method for any given event reminder can be determined or calculated as a function of user-input event importance or simply by time remaining to event, as a basis for selecting reminder delivery method for each reminder at its respective point in time and distance from the event. In the preferred embodiment, the reminder priority equals the event importance divided by time remaining to the event at time of reminder.

pₙ=i/Tₙ
where pₙ is the priority of the n^{th} reminder,
i is the importance of the event associated with the time series, and
Tₙ is the length of the time span between the n^{th} reminder time and the event time, or tₑ−tₙ

In an alternative embodiment, a reminder's delivery method may be automatically selected purely on reminder priority calculated as time remaining to event. For example, reminders for events more than a day away may be delivered via email while anything sooner being delivered via a more immediate media such as text message. User preference configuration can control this aspect of system behavior.

In another alternative embodiment, a reminder's delivery method may be automatically selected on reminder priority as a time sensitivity such as absolute or percentage change in time remaining to event per unit time, for example an event 4 days from now changes in absolute priority from i/4 to i/3 over the next one day period in the preferred embodiment. This differentiates reminders by selecting a reminder delivery method appropriate to the level of time sensitivity, time criticality, or immediacy of response required. Delivery media include many possible reminder delivery methods such as to-do list (a report), email, SMS text without sound, SMS text with sound, popup on a computer screen, smart watch vibrate, phone call, etc. Email is generally received more slowly than a text message which is slower still than a phone call. It is desirable for higher priority (higher time sensitivity) reminders to be delivered on media that will be seen sooner by the user.

A user entered volume setting per delivery method can determine threshold activation levels in terms of priority, importance, or time to event. Upper and lower priority bounds per delivery method assign reminders or not to those delivery methods. A global volume setting across devices can scale all delivery method thresholds up or down, creating periods of relatively more or fewer interrupting reminders across devices. A report listing upcoming events or task due dates is a form of passive reminder for lowest priority reminders or for events furthest out in time. Management of related information within a reporting and analytic framework illustrates a portfolio analysis approach to events and deadlines and to their reminder series.

In general, according to one aspect, the invention features reminders thereby having a numeric reminder priority assigned, defined in the preferred embodiment as event importance divided by time remaining to the event, as of the reminder time. A reminder is said to have a priority based on its associated event importance and on time to event as of the reminder. This metric provides the basis for automated reminder device selection.

It should be noted that the reminder rate and event importance are distinct and controlled independently by the user typically at the user interface. The reminder rate specifies timing of reminders, whereas the event importance concerns the value of that event. Although reminder rate and event importance are independently controlled, it is understood that the setting of event importance and reminder prevalence could be connected or correlated or controlled automatically by the system.

Because the reminder series implied by a generating function never ends, a cancellation point is useful, so that reminders do not eventually arrive continuously with no delay in between as event time becomes near. A reminder series cancel point serves this purpose and may be specified as part of the reminder series definition. Cancel point may be alternatively indicated as a point in time or as a count of reminders desired. A minimum dwell time would be another way to limit the frequency or density of a reminder series, without cancelling the series, for example this may be a user indication to limit a reminder series to one reminder every five minutes.

In one aspect of the invention, a numeric volume control may be defined to scale the threshold priority levels above or below which reminders of a given priority would manifest for various reminder delivery methods. In addition, the level or mode of a reminder within a given delivery method can also be controlled by priority. For example, the audible alarm level on the sound associated with a popup reminder on a computer, or the selection of a cell phone ring tone on a phone call reminder could be impacted by the reminder priority.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a block diagram overview of the calendar system inputs, outputs, and processing for a computing system according to the present invention;

FIG. 2 shows a user interface presented on a display of a user device enabling the user to specify an event reminder series, importance, and cancel point according to the present invention;

FIG. 3 shows a plot of the reminder time series for an exemplary event, according to the invention;

FIG. 4 shows a systems and methods flow chart including actors, decision points, and key operations of the calendar system;

FIG. 5 shows a user interface presented on a display of a user device enabling reporting, graphical and dynamic portfolio calendar management;

FIG. 6 shows a graph of reminder priority as a function of time showing the concept of volume control thresholds of reminder delivery methods relative to reminder priority;

FIG. 7 is a flowchart illustrating alternative equivalent representations for user data entry of reminder rate and cancel point.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

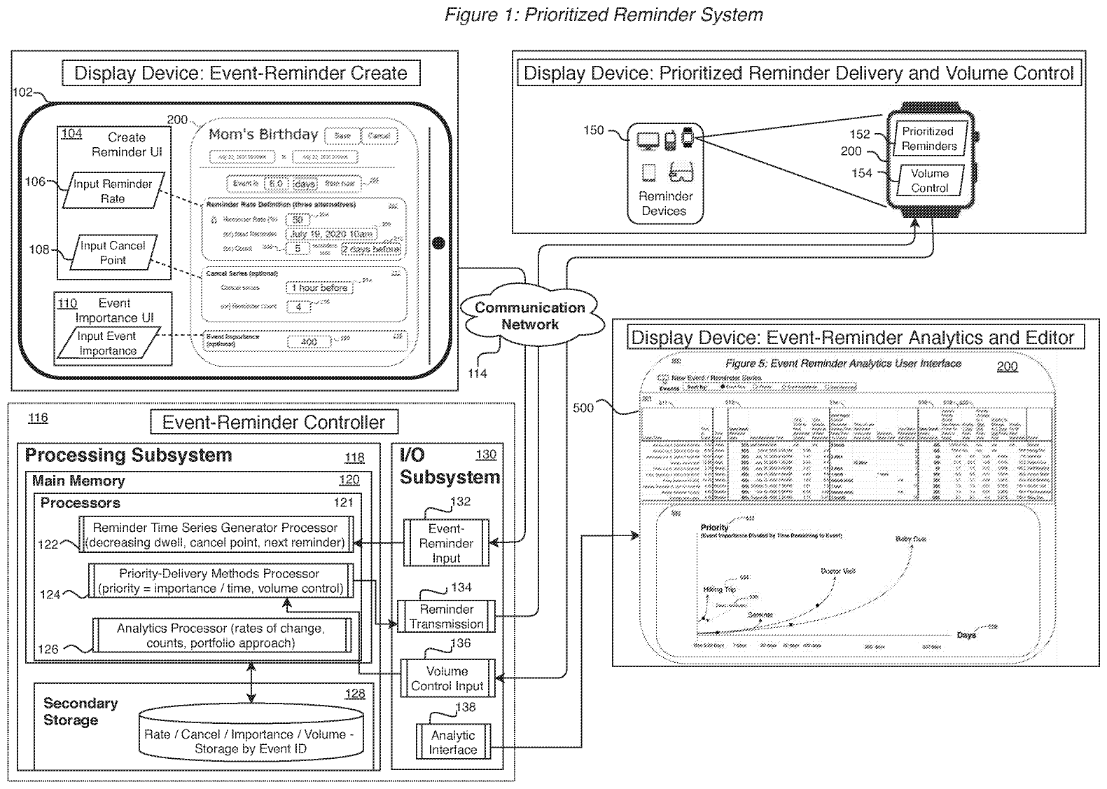

FIG. 1 illustrates a multi-device computing system in accordance with an exemplary embodiment of the current invention for event-reminder creation and for consumption and management of reminders of a calendar system, by a user over time.

In the illustrated exemplary use-case, reminders are created by the user operating a user interface displayed on a display 200 of one or more user devices 102, 150, 500. Reminders might be displayed on the same user device 102 and/or to reminder device 150 such as a smart watch.

The user devices 102, 150, 500 according to various embodiments may generally include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a pair of glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

The user devices 102, 150, 500 typically operate within a network environment 114. In addition, the user devices 102, 150, 500 may each include a bus, a processor, a memory, an input/output interface, respective displays 200, and a communication interface. Note that the electronic device may omit at least one of the above components or may further include other components.

The user devices 102, 150, 500 may include one or more of a Central Processing Unit (CPU), an Application Processor (AP), and a Communication Processor (CP). The processor may carry out, for example, calculation or data processing relating to control and/or communication of at least one other component of the electronic device. The processor(s) interact with memory, which may include a volatile memory and/or a non-volatile memory. The memory may store, for example, commands or data relevant to at least one other component. According to an embodiment of the present disclosure, the memory may store software and/or a program that are part of the calendaring system.

Examples of the display 200 of the user devices 102, 150, 500 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display may display, for example, various types of contents (e.g., text, images, videos, icons, or symbols) to users. The display may include a touch screen, and may receive, for example, a touch, gesture, proximity, or hovering input using an electronic pen or a user's body part.

Shown is a schematic of devices, services, and user interfaces for a user to create a reminder time series via a generating function in a series generator processor 122 based on a user entered reminder rate 106, optionally including a user entered series cancel point 108, and optionally including a user entered event importance 110, which in the illustrated embodiment are entered via the user interface displayed on display 200 of user device 102.

In a typical example, the series generator processor 122 is a function performed by an event reminder controller 116 which is a server or group of one or more servers forming a cloud backend server system for the calendar system. However, in other embodiments, series generator processor 122 and the other functions of the controller 116 of the calendar system execute on one or more of the user devices 102, 150, 500.

Over time reminders are delivered back to the user via the reminder devices 150. Each reminder may be delivered with a calculated priority indication 124 defined in the exemplary embodiment as event importance divided by time remaining to the event. A user entered volume control, based on upper and lower bounds of reminder priority per reminder device, determines which reminders will activate on which devices or with what delivery method specifics.

The central logic, triggering, and coordinating component is the event reminder controller 116 whose processing subsystem 118 includes main memory 120 housing multiple processors 121 for application function, as well as housing secondary storage 128 for persistence of user data, events, and reminder series.

Three processors 121 are responsible for reminder time series time points generation 122 as well as delivery method selection 124, based on input signals received via the I/O subsystem 130 as driven by display devices 200 of the user devices 102, 150, and 500. The system coordinates across the communication network 114, such as the internet, transmitting information via the input-output subsystem 130 between the processors 121 and display devices 200 of the user devices 102, 150, and 500.

User devices 102, 150, and 500 are understood to have embedded or connected computing devices such as desktop or mobile personal computing devices, which each include input devices such as keyboard, mouse, pointer, touchscreen display, finger, gesture, voice, etc. but other such hardware and software elements are not shown for purposes of clarity. Display devices 200 render user interfaces for reminder creation on the user device 102, for prioritized reminder delivery 152, for volume control 154, and for dashboard event-reminder viewing and analysis 500. The input output subsystem 130 connects, via the communication network 114, to the multiple display devices for receiving control signals from the user interfaces and for transmitting reminders.

Event-reminders are defined by the user via the event-reminder create user interface which is displayed on one of the user's computing devices, here display 200 of user device 102. Creation happens at create time for reminder receipt by a user at scheduled times in the future. A reminder series may be associated with a single event. The create reminder user interface on display 200 allows the user to schedule reminder times in the reminder series for an event. The reminder time series generator processor 122 executes a function to determine reminder times. In the preferred embodiment, this is a generator function taking as input the reminder rate 106, a reminder creation time and event time. The generator function may be written or implemented as a recurrence relation, in the sense of defining a next reminder time or dwell based on previous reminder times or dwells. Each reminder period is based on the same generator function providing a predictable pattern to the user across periods.

It is understood that multiple events could be grouped or collected into categories such that a single reminder series or series type could be associated with multiple events. It is understood further that multiple users could be grouped or collected into categories such that a single reminder series or series type could be associated with multiple users.

A prioritized reminder 152 displayed on the display 200 of the reminder device 150 is a reminder with a priority measure affixed. Under one embodiment, the reminder priority is a function only of time remaining to the event. Under one embodiment, priority may be calculated by the priority delivery methods processor 124 as one divided by time remaining to event. In this manner, as the system clock time approaches event time, the reminder priority goes up in an ever-increasing fashion that is non-linear in time.

The event importance user interface 110 displayed on the display 200 of user device 102 allows the user to enter a numeric or ordinally ranked importance measure for the associated event, for storage 128 as a property of the event and reminder series.

A full reminder series specification includes reminder rate 106, reminder series cancel point 108 (optional) and event importance 110 (optional).

A single reminder may be delivered on one or more user and/or delivery devices or via one or more delivery methods to the user devices 102, 150, 500. The reminder priority is calculated by the priority delivery methods processor 124 and is used both as a determinant of a reminder delivery method, as well as to determine the reminder's delivery methods across devices based on a volume control 154 user setting.

Some delivery methods may have varying levels (e.g., audible alarm sound levels) or varying reminder indicator modes (e.g., which ring tone on a cell phone call). Under one embodiment, if a reminder were targeted to a cell phone notification tone, such as the delivery method, the loudness of the notification, or the sound chosen, could be correlated to reminder priority.

In the preferred embodiment, where the associated event has an importance assigned, reminder priority (also called the event priority at reminder time) is defined as event importance divided by time remaining to event as calculated by the priority delivery methods processor 124. The priority of a reminder may be used to determine a delivery method for that reminder, e.g., via email vs via text message, based on volume settings which are specified by the priority-delivery method processor 124, transmitted via a volume control input message 136, and then generated via a volume control 154 of user device 150.

Under one embodiment, volume control 154 is given as a user input indication of minimum and maximum reminder priority level as a filter for which reminders appear on which devices 150 or at what reminder level (e.g., sound level). A master volume control can scale up or down all device priority thresholds as means to create periods of relative quiet or with fewer reminder interruptions, say relegating some or all reminders to a record in a reminder report so as not to interrupt the user with each reminder. Other related controls of the reminder series are also possible such as a minimum dwell time, indicating never to deliver reminders for this series more than once every 5 minutes.

The cancel point 108 is an a priori indication of the series truncation point, selected by the user via the user interface displayed on display 200 of user device 102. The cancel point 108 is a time indication beyond which time no reminders will be emitted, defining the last desired reminder time in the series. Under the embodiment as shown, cancel point can be indicated by the user either as a time 214 or as a count 216 of reminders desired via user device 102.

Given a measure of priority as a function of importance and time, the analytics processor 126 calculates rates of change in priority per unit time, as a measure of the time dynamics of the event-reminder priority.

The event-reminder series and importance can be adjusted over time as to reminder rate 106, cancel point 108, event importance 110, and volume control 154.

Processors are conceptually shown for purposes of illustration as residing in main memory. Persons skilled in the art to which the invention relates understand that, in accordance with well-understood computing principles, such software elements do not necessarily reside in their entireties in such a memory 120, but rather are retrieved from a data storage device 128 (e.g., a solid state disk drive) in modules or other portions on an as-needed basis under control of the processor 118. Persons skilled in the art to which the invention relates also understand that an input device may be substituted by an application programming interface through which user or other inputs may be programmatically collected. The elements shown may be configured with other software elements of the types typically included in such a system, such as an operating system (e.g., of the Microsoft Windows® operating systems or Microsoft Outlook®), but such other software elements are not shown for purposes of clarity. Processor 118, memory 120, storage 128, and associated hardware and software elements are commonly included for purposes of providing the processing function in such a computer system and can be considered to constitute the controller system 116.

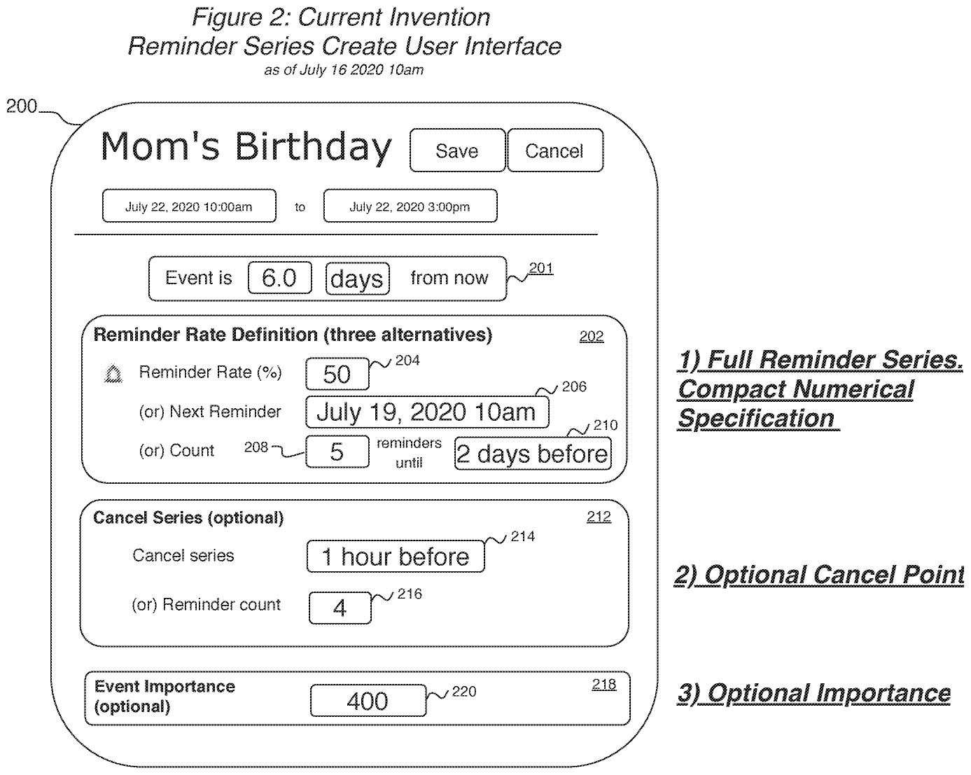

FIG. 2 illustrates a reminder series and event definition user interface displayed on display 200 of user device 102 which may be integrated into existing calendar reminder systems such as Microsoft Outlook®. The user interface encompasses traditional calendar data entry.

In the exemplary embodiment, the “event time from now” display 201 is a user convenience showing the amount of time between now (e.g., event-reminder creation time) and the time of the event. It is shown as an aid to the user in reminder series definition.

In the exemplary embodiment, reminder rate may be specified 202 in any of three forms as alternative representations by the user. As a percentage 204, rate indicates the percentage of the time to the event at which the next reminder would occur. For example, the user setting a reminder rate of 50% means that the next reminder will be halfway to the event. Reminder rate can be adjusted up (down) by the user reflecting the user's desire for more (less) frequent reminders about a given event. Given a user input next reminder time 206 the percentage can be calculated easily but offers the user a different way of thinking about the upcoming reminder and future reminders pattern. Count of reminders 208 until a time horizon point in time 210 is a third option for input reminder rate representation for the user. The reminder rate can be calculated from either of the other two alternative representations and is the parameter to the series generator function 122.

Because the reminder series as mathematically defined by a generating function may be unending and increasing in frequency, a cancel point is needed. The exemplary embodiment series cancel point user interface 212 takes as input a point in time 214 beyond which reminders cease to exist. Alternatively, a total reminder count 216 may be specified as desired from the reminder series. Cancel point is an optional input in that the user may choose to instead cancel the series manually later.

Event importance 220 is specified by the user and is a measure of event value or worth to the user and may variously represent a money amount to “not miss” an event, the money value of properly attending to a task, a probability of attending an event, or to the amount of preparation work required for an event. It is an input to the priority delivery methods processor 124.

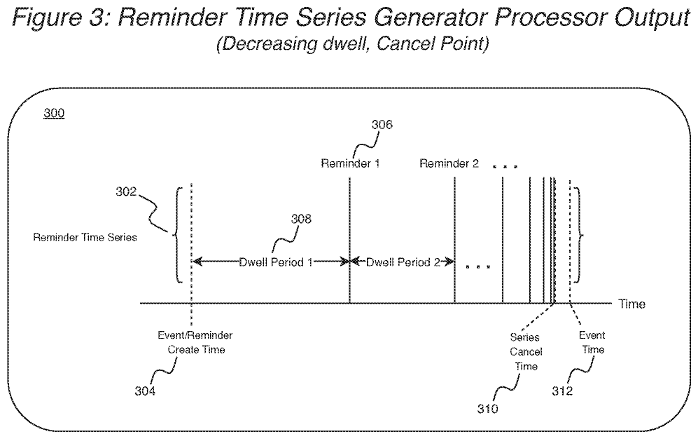

FIG. 3 is a graphic illustration of the time points of a reminder series 302 as output by the series generator 122. Each reminder time 306 is computed in similar fashion by the generating function. The function may compute a reminder time directly, or it may calculate a dwell period time duration 308 as a time span offset to a next reminder from a previous, from series create time, or from a forward reminder start time. The series is cancelled as of cancel time 310 prior to event time 312. Note decreasing dwell (inter-reminder time) and termination at a cancel point.

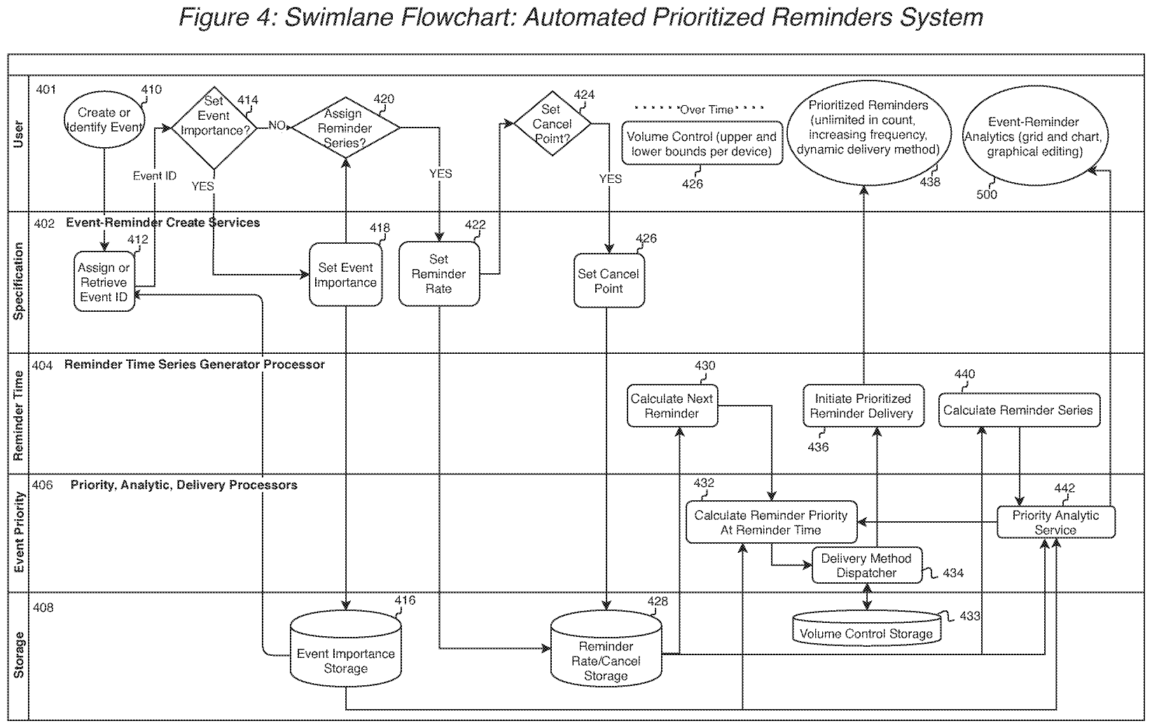

FIG. 4 is a swim lane workflow and data flow diagram according to an exemplary embodiment showing the life cycle of decision and actions leading to scheduled reminders delivered via volume-controlled delivery methods based on reminder priority. A user 401 initiates creation or retrieval of an event 410 on user device 102, for example. An event may be a task, a deadline, a rolling deadline, or any point in time about which a user desires one or more reminders. If the event is new, then a new event ID can be assigned or if existing 412 then the existing event ID can be retrieved from event storage 416.

The user 401 decides 414 whether to assign an importance to the event and if so then the event reminder create services 402 accepts event importance 418 as user input persisted in event storage 416.

The user decides whether to associate a reminder series with the event 420 and, if so, then the event reminder create services 402 accepts reminder rate 422 as user input persisted in reminder rate storage 428.

The user decides whether to set a cancel point on the reminder series 424 and, if so, then the event reminder create services 402 accepts cancel point 426 as user input persisted in cancel storage 428.

At this point the event and reminder series are defined such that reminders can be calculated for delivery at specified points in time via specified delivery methods. The reminders time series generator processor calculates a next reminder time 430 for the series for reminder delivery.

Volume control settings may be specified 426 at create time or may be adjusted over time by the user 401 for persistence by volume control storage 433. Volume control is a means to specify numerically, or in terms of a ranking, the range of reminder priority levels to be manifested across delivery devices and methods. For example, priority from 0 to 200 may be indicated for email delivery while 150 and higher may be indicated for text message, reflecting the faster average view time of a reminder delivered via text relative to email. Volume control (prevalence of reminders) may also be implemented by respecting a user entered minimum dwell (inter-reminder) time.

Given a reminder time, the priority delivery methods processor 406 calculates a reminder priority 432 for determination by the delivery method dispatcher 434 as to which delivery methods will be initiated for each reminder. Note that a given reminder may be delivered via multiple delivery methods. Reminder delivery is posted for delivery 436 by a scheduler or queuing process resulting in delivery of prioritize reminders 438 to the user.

The priority analytic service 442 takes the full set of events and reminder series 440 to populate grid and chart views in an exemplary embodiment calendar or task management dashboard user interface 500. Reminder series 440 can be fully enumerated in order to include counts and displays of reminders over time.

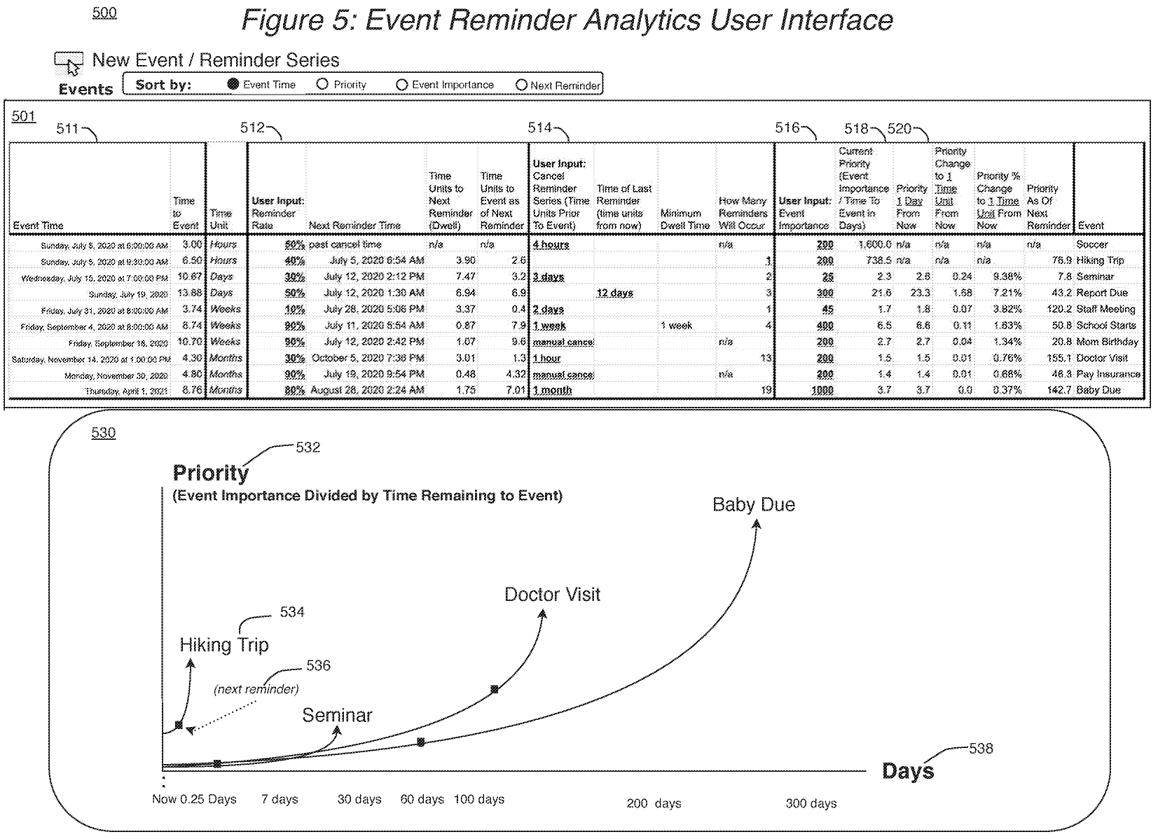

FIG. 5 illustrates an exemplary embodiment of a calendar or to do list task analytics and management dashboard displayed on the display 200 of user device 500. The purpose of the dashboard is to provide an easy to read unified display or control panel, summarizing and highlighting relevant information, and allowing for sorting and filtering by various categories and measures. Events are indicated with their times in the grid view 501 offering spreadsheet-like functions for managing across events and reminders.

The reminder rate 512 for each reminder series associated with an event 511 is displayed along with next reminder time, time to next reminder, and time until the event from that reminder time. The user input cancel time 514 is an indication in one of multiple possible representations of the time beyond which reminders in the series will cease to exist. The user input event importance 516 is a numerical indication of value, worth, or significance of that event. Current priority of the event is shown 518 independent of next reminder time.

Change in priority level over time or instantaneous (e.g., first derivative) rate of change in priority 520 are available as measures of the immediacy or time-sensitivity of a given event or reminder series. For example, if a reminder priority is going up by 50% by tomorrow or changing by 200 priority units by tomorrow, then that is an indication that the passage of time (e.g., waiting one more day on a calendar to-do) is more or less significant for that reminder series.

Such absolute and percentage rates of change in priority may be used as additional inputs into the delivery method dispatcher 434, which implements the volume control function and routing function for assigning reminders to devices or for determining alert levels such as speaker level in an audible alarm. The chart view 530 is a rendering of some of the same event and reminder details as in the grid, but offering a graphical form in which both dimensions time (days) 538 and priority 532 can be easily summarized and reviewed. Named events 534 including their priority and next reminder 536 are shown. Events and reminders can be manipulated in this view graphically.

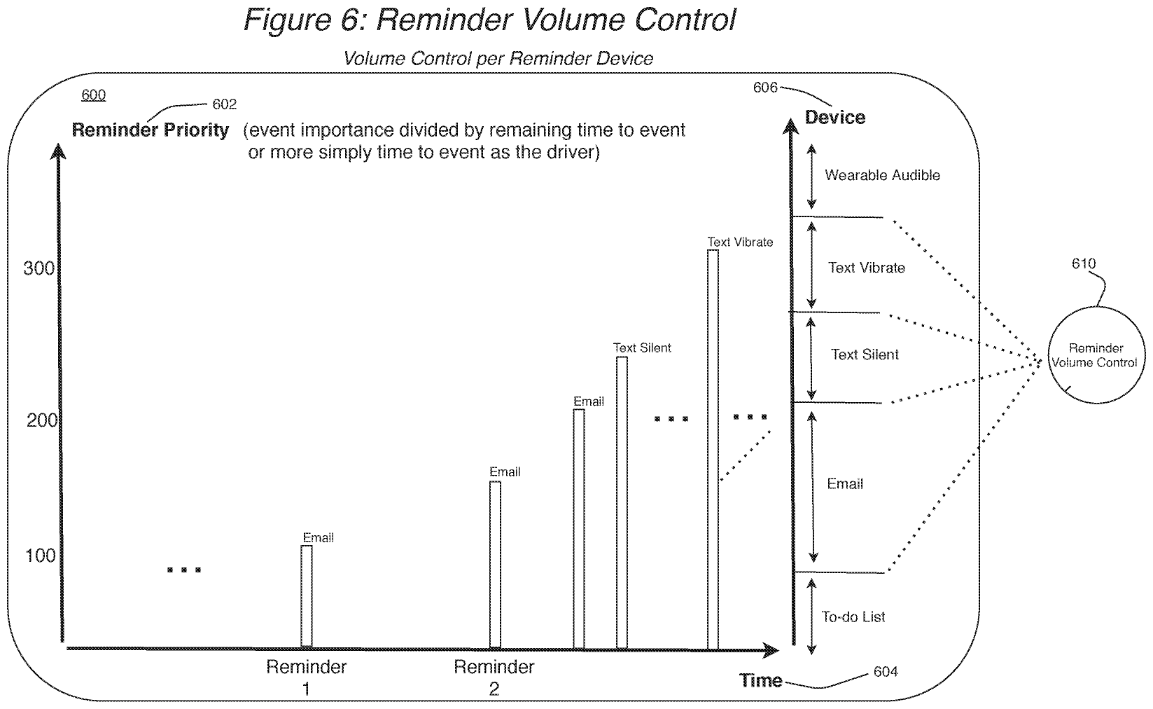

FIG. 6 illustrates an exemplary embodiment of a volume control setting function 600 which is displayed on the display 200 of user device 500. Here, the reminder priority 602 is mapped (uniquely in this example) to a reminder device or delivery method 606. Adjusting the priority threshold cutoff points 610 along the device dimension 606 between delivery methods defines upper and lower bounds for selection of a delivery method given a priority 602.

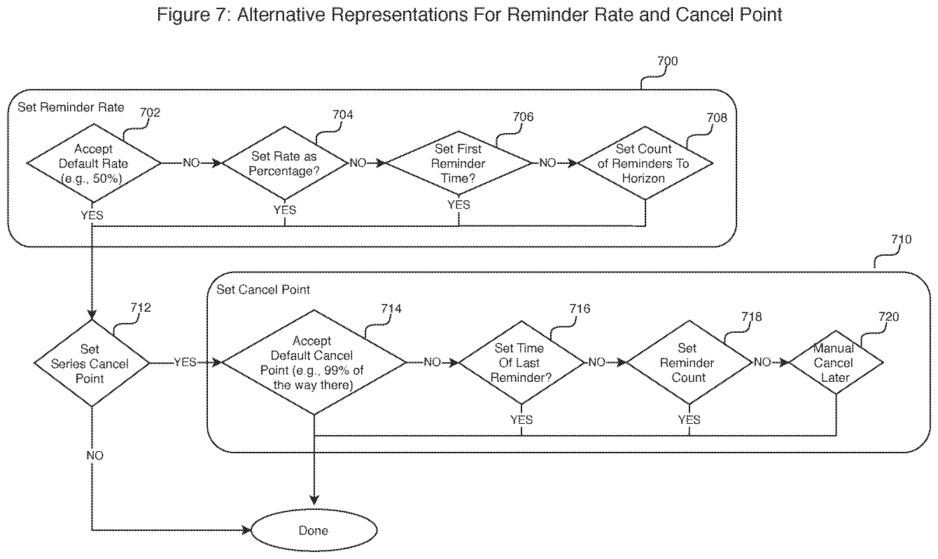

FIG. 7 illustrates, under the exemplary embodiment, various alternative representations for reminder rate 700 and cancellation point 710. The system defines a default reminder rate of 50% 702 so that the user can define a reminder series without having to enter a rate. Alternatively, the user may set rate by percentage other than the default 704. First reminder time 706 or count of reminders 708 to a horizon point in time are alternative means of specifying rate. Either chosen representation for reminder rate determines the value of the rate parameter passed into the generating function 122.

If the user chooses to specify a cancellation point 712 there are again multiple means of representing or specifying the same cancel point information. These include: accepting a default percentage of the time interval to event time 714, a non-default time of last reminder 716, a count 718 of desired reminders in the series, or deferring the cancel point decision until later when a manual cancel by the user indicates that reminders have become too frequent or are sufficiently close to event time that no further reminders are desired.

### TERMS AND REFERENCE LIST

### Key Terms

Event
Time of the Event
Time Remaining to Event (same as Time to Event)
Event Reminder (same as Reminder)
Reminder Time
Reminder Time Series
Delivery Method of Event Reminders—the hardware (e.g., display device) and software medium over which reminders are communicated
User Entered Reminder Rate (input parameter to the reminder time series generating function modulating reminder counts)
Mathematical Generating Function
Mathematical Recurrence Relation (a generating function using recurrence)
User Entered Event Importance
Priority (e.g., importance divided by time remaining to event)
Reminder Priority (Event Priority at time of reminder)
User Entered Cancel Point—a date-time (or count of reminders) specifying when a reminder time series should terminate
Dwell Period (inter-reminder time)
User Entered Volume Control—lower and/or upper thresholds (e.g., per device) defining on which devices a given reminder will be activated
User Display Device—computing and communication devices for reminder and event specification, for receiving reminders, and for event-reminder portfolio analysis
116 Event-Reminder Controller—the system responsible for interfaces, logic, and for storage of events and initiation/delivery of prioritized reminders
122 Reminder Time Series Generator Processor—processes rates and cancel points into a reminder time series based on a generating function
124 Priority-Delivery Methods Processor—the processor that calculates a priority based on importance and/or time remaining to event
126 Analytics Processor—the processor that renders and supports the analytic interface including reminder counts and rates of priority change as a time-sensitivity measure
128 Secondary Storage—persistence for all system information including users, events, and reminders
130 I/O Subsystem—programmatic and human interfaces for defining, communicating, and managing events and reminders
150 Reminder Delivery Devices—hardware and software mechanisms for delivering reminders to the user
152 Prioritized Reminder—a reminder with priority affixed
154 Volume Control—modulation of reminders in terms of count or level, may be specified per delivery device
201 Time From Now Panel—user convenience display of time remaining until event
202 Reminder Rate Definition Panel—example UI for reminder rate input
204 Reminder Rate—as a percentage
206 Next Reminder—reminder rate specified as a date-time of next reminder
208/210 Count of Reminders—reminder rate specified as a count of reminders to a date-time
212 Cancel Series Definition Panel—example UI for cancel point input
214 Cancel Point Field—cancel point as a (relative) date-time
216 Cancel Count Field—cancel point as a count of reminders desired
218 Event Importance Definition Panel—example UI for event importance input
220 Event Importance Field—event importance indicator
300—Reminder Time Series Generator Processor Output—abstract representation of reminder time series
302—Reminder Time Series—the collection of time points output by the generating function
304—Event/Reminder Create Time—time zero for reminder series
306—Reminder 1—first reminder in the series
308—Dwell Period 1—the dwell (e.g., inter-reminder) period leading to the first reminder in the series
310—Series Cancel Time—the time point beyond which no further reminders exist/manifest
312—Event Time—date-time of the event for the given reminder series
442—Priority Analytic Service—logical and quantitative operations supporting grid and chart views including reminder counts and rates of priority change
520—Priority Change—the rate of change (in absolute priority units or as a percentage) of priority over a time period, as an event reminder time-sensitivity measure
600—Reminder Volume Control—mapping of reminder priority to delivery method (or device) as a control of reminder quantity and as an interruption governor
610—Reminder Volume Control—tuning knob for setting lower and upper reminder priority thresholds per delivery method
700—Manual Cancel—cessation of reminder series not a priori, but at some point in the future based on a user trigger

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for calendaring events, wherein event reminder times of an event reminder series are generated using a mathematical generating function.

2. A system of claim 1, wherein the mathematical generating function can be written as a mathematical recurrence relation.

3. A system of claim 1, wherein the same mathematical generating function is applied at each event reminder time to derive a next event reminder time.

4. A system of claim 1, wherein the same mathematical generating function is applied at each event reminder time in the series to derive the next inter-reminder time period length.

5. A system of claim 1, wherein the next event reminder time is a function of a time remaining to the event.

6. A system of claim 1, wherein a time to the next event reminder decreases as the time of the event is approached.

7. A system of claim 1, wherein a time to the next event reminder decreases monotonically as the time of the event is approached.

8. A system of claim 1, wherein a time to the next event reminder decreases exponentially as the time of the event is approached.

9. A system of claim 1, wherein the generating function takes as a parameter a user entered reminder rate to determine the reminder series times.

10. A system of claim 1, wherein the reminder rate indicates next reminder time as a percentage of the time from the current reminder to the event.

11. A system of claim 1, wherein the reminder series is terminated based on a user entered cancellation point in time.

12. A system of claim 1, wherein series reminders will be governed so that inter-reminder time will not be less than a user entered minimum duration of time.

13. A system of claim 1, wherein the priority of event reminders is determined based on a user entered event importance.

14. A system of claim 1, wherein the priority of event reminders is determined based on the time remaining to the event as of the event reminder time.

15. A system of claim 1, wherein the priority of event reminders is calculated as the user entered event importance divided by the time remaining to the event as of the event reminder time.

16. A system of claim 1, wherein the delivery method of event reminders is selected from among a plurality of delivery methods based on the event reminder priority.

17. A system of claim 1, wherein the reminder delivery method of the event reminders is selected from among a plurality of delivery methods based on the absolute change in reminder priority per unit time.

18. A system of claim 1, wherein the reminder delivery method of the event reminders is selected from among a plurality of delivery methods based on the percentage change in reminder priority per unit time.

19. A method for calendaring events in a computing system, the method comprising
enabling users to specify events; and then
generating event reminder for the users using a mathematical generating function.

20. A method of claim 19, wherein the mathematical generating function is a mathematical recurrence relation.
